(19) United States
(12) Patent Application Publication
(10) Pub. No.: US 2002/0075508 A1
(43) Pub. Date: Jun. 20, 2002

(54) Notification of print job status over a wireless link

(76) Inventor: David J. Luman, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/742,163

(22) Filed: Dec. 20, 2000

(51) Int. Cl. G06F 13/00; G06F 15/00; G06F 3/12

(52) U.S. Cl. 358/1.15

(57) ABSTRACT

A printing system product comprises initiating software and control software stored on processor-readable storage media. The initiating software directs an initiating device to receive a print request including a wireless notification request, and in response, to transfer a corresponding print job with wireless notification instructions to a printing device. The control software directs the printing device to receive the print job with the wireless notification instructions, and in response, to direct the printing device to perform the print job and transfer print job status over a wireless link to a wireless receiver.

### BACKGROUND OF THE INVENTION

1. Field of the Invention

The invention is related to the field of printing systems, and in particular, to a printing system that notifies a user with print job status over a wireless link.

2. Statement of the Problem

In the typical printing scenario, a computer receives a print request from a user, and in response, the computer submits a corresponding print job to a printer. The computer often provides the user with various printing options that control how the print job is carried out by the printer. In response to the print job, the printer produces paper copies of the requested materials. During the print job, the printer may send print job status messages to the computer to notify the user. The messages may indicate problems, such as running out of paper, or they may indicate completion of the print job.

Unfortunately, the user cannot receive the print job status messages if they move away from their computer. If there is a print job problem while the user is away from their computer, the user does not know of the need to fix the printer, and completion of the print job is delayed until the user returns to their computer and receives the problem message. While the user is away from their computer, they do not know if the print job is complete. The user may make repeated trips to the printer to see if the print job is complete. In addition, the completed print job may sit at the printer for a lengthy period of time until the user returns to the printer. The print job may be undesirably viewed or tampered with during this time period.

Some printers are configured to provide general statistics and some control to other computers. For example, a printing system administration computer can view the print queue and stop some print jobs while giving others a higher priority. Unfortunately, the administration computer is of little help to the user when they move about.

### SUMMARY OF THE SOLUTION

The invention helps solve the above problems with printing system products and methods that provide wireless notification of print job status. The user may receive notification of print job status over a wireless link to their personal digital assistant or mobile telephone. Advantageously, the user is notified of print job problems and completion as they move about.

Some examples of the invention include a printing system product comprising initiating software stored on processor-readable storage media. The initiating software is configured to direct an initiating device to receive a print request including a wireless notification request, and in response, to transfer a corresponding print job with wireless notification instructions to a printing device. The wireless notification instructions are configured to direct the printing device to transfer print job status over a wireless link to a wireless receiver. The wireless receiver is a different device from the initiating device. The initiating software may be configured to direct the initiating device to collect an identification of the wireless receiver, a selection to either include or exclude print job completion in the print job status, and a selection to either include or exclude print job problems in the print job status.

Some examples of the invention include a printing system product comprising control software stored on processor-readable storage media. The control software is configured to direct a printing device to receive a print job with wireless notification instructions, and in response, to direct the printing device to perform the print job and transfer print job status over a wireless link to a wireless receiver. The control software may be configured to direct the printing device to transfer print job status over the wireless link to the wireless receiver by transferring a message to a wireless transmitter. The message indicates the print job status and identifies the wireless receiver. In response to print job completion, the control software may be configured to direct the printing device to transfer print job status indicating the print job completion over the wireless link to the wireless receiver—and maybe then only if the wireless notification instructions include the print job completion in the print job status. In response to a print job problem, the control software may be configured to direct the printing device to transfer print job status indicating the print job problem over the wireless link to the wireless receiver—and maybe only then if the wireless notification instructions include the print job problem in the print job status.

### DESCRIPTION OF THE DRAWINGS

The same reference number represents the same element on all drawings.

FIG. 1 is a block diagram that illustrates a printing system in an example of the invention.

FIG. 2 is a block diagram that illustrates an initiating device in an example of the invention.

FIG. 3 is an illustration of a printing options display in an example of the invention.

FIG. 4 is a flow diagram that illustrates initiating device operation in an example of the invention.

FIG. 5 is a block diagram that illustrates a printing device in an example of the invention.

FIG. 6 is a flow diagram that illustrates printing device operation in an example of the invention.

### DETAILED DESCRIPTION OF THE INVENTION

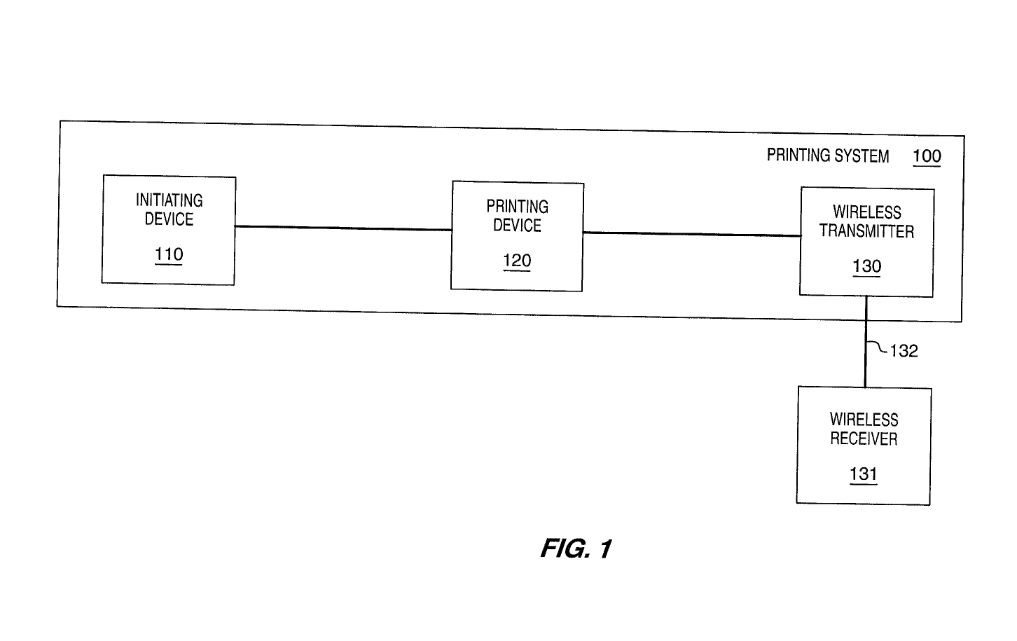

Printing System—FIG. 1

FIG. 1 is a block diagram that illustrates printing system 100 in an example of the invention. Printing system 100 is comprised of initiating device 110, printing device 120, and wireless transmitter 130. Wireless transmitter 130 communicates with wireless receiver 131 over an air interface using wireless link 132. Printing device 120 is operationally coupled to initiating device and wireless transmitter 130. A communication network or link could be used for the operational coupling. In addition, wireless transmitter 130 may be integrated into printing device 120.

Initiating device 110 receives a print request. The print request includes a wireless notification request that identifies wireless receiver 131. In response to receiving the print request, initiating device 110 transfers a print job with wireless notification instructions to printing device 120.

Printing device 120 receives the print job with the wireless notification instructions from initiating device 110. Printing device 120 performs the print job by producing a paper copy of the materials indicated in the print job. Printing device 120 also transfers print job status through wireless transmitter 130 to wireless receiver 131 over wireless link 132.

Wireless transmitter 130 communicates over wireless link 132 with wireless receiver 131. Wireless receiver 131 could comprise a personal digital assistant, a mobile telephone, or a similar type of wireless communication device. One example of a personal digital assistant is the PALM PILOT. Wireless receiver 131 typically registers with wireless transmitter 130 when in range. If desired, the communications could use instant messaging where wireless transmitter 130 transmits an instant message to wireless receiver 131 over wireless link 132, and wireless receiver 132 instantly displays the message. Wireless transmitter 130 and wireless receiver 131 could be a conventional wireless communication system.

In a typical example of printing system 100 operation, the user operates initiating device 110, such as a personal computer, to submit a print job to printing device 120. The print job includes instructions for wireless notification of print job status. The user may then move about with wireless receiver 131, such as a personal digital assistant. Note that wireless receiver 131 may be a different device from initiating device 110. If there is a print job problem, such as running out of paper, printing device 120 transfers a print job problem message through wireless transmitter 130 to wireless receiver 131 over wireless link 132. Despite moving away from initiating device 110, the user receives the problem message over wireless receiver 132 and can go to printing device 120 to fix the problem. When the print job is complete, printing device 120 transfers a print job complete message through wireless transmitter 130 to wireless receiver 131 over wireless link 132. Despite moving away from initiating device 110, the user receives the job complete message over wireless receiver 132 and can go to printing device 120 to pick up the printed materials. Advantageously, the user may move about without compromising the ability to efficiently print materials.

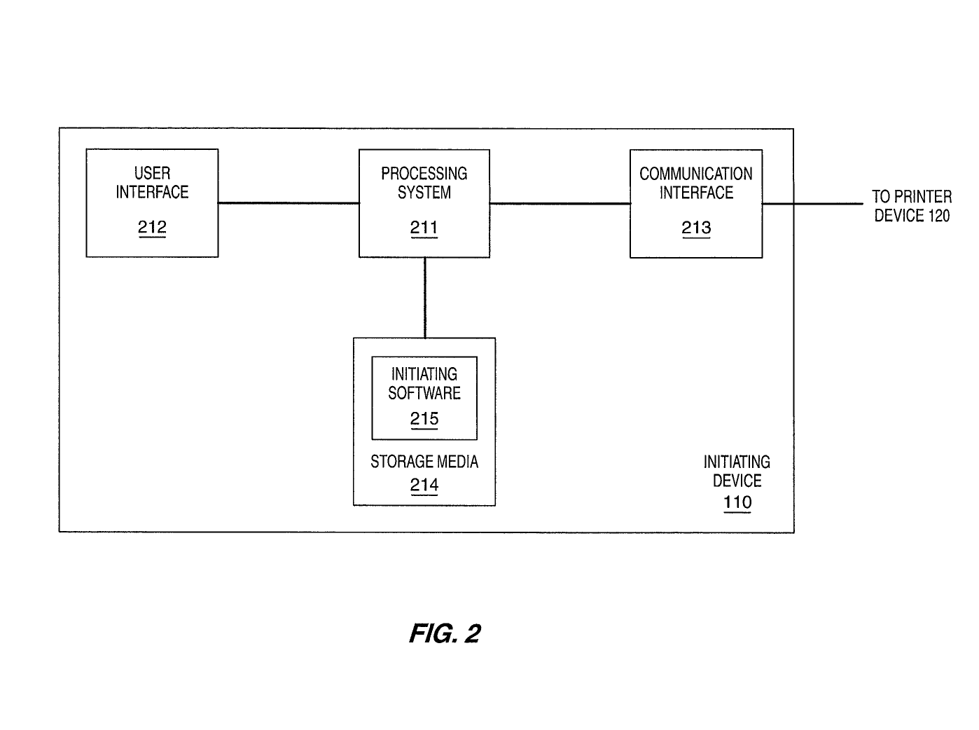

Initiating Device—FIGS. 2-4

FIG. 2 is a block diagram that illustrates initiating device 110 in an example of the invention. Initiating device 110 is comprised of processing system 211, user interface 212, communication interface 213, and storage media 214. Storage media 214 stores initiating software 215. Communication interface 213 is operationally coupled to printing device 120. Initiating device 110 could be comprised of a personal computer running an operating system and application software.

Processing system 211 includes computer circuitry to read and execute initiating software 215 from storage media 214. Storage media 214 could be disks, integrated circuits, tapes, servers, or some other type of memory device. Storage media 214 does not necessarily have to reside within initiating device 110. Initiating software 215 could comprise any processor-readable instructions—including programs, firmware, or encoded circuitry—that are operational when executed by processing system 211 to direct processing system 211 to control the operation of initiating device 110.

User interface 212 could be comprised of components, such as a display, keyboard, and mouse, that facilitate communication with the user. Under the direction of initiating software 215, processing system 211 transfers display signals to user interface 212, and in response, processing system 211 receives user selection signals from user interface 212. Communication interface 213 could be comprised of components, such as a network interface card, that facilitate communication with printing device 120.

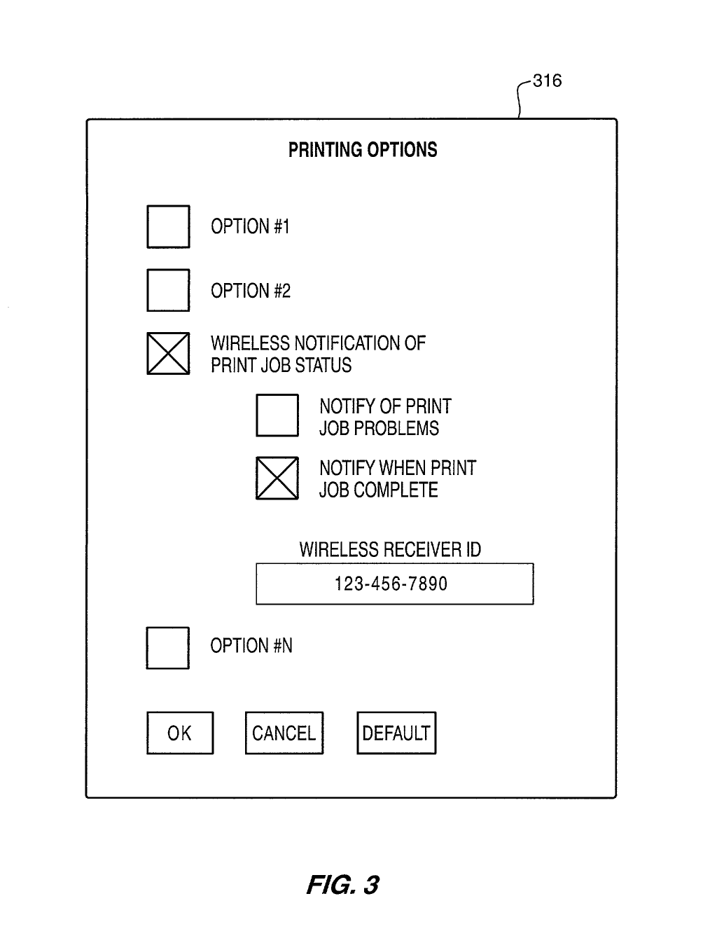

FIG. 3 is an illustration of printing options display 316 in an example of the invention. The user could obtain printing options display 316 by using user interface 212 to select File—Print—Options. Printing options display 316 includes check boxes with various options 1-N. One of the options is WIRELESS NOTIFICATION OF PRINT JOB STATUS. This option has at two sub-options: 1) NOTIFY OF ANY PRINT JOB PROBLEMS, and 2) NOTIFY WHEN PRINT JOB IS COMPLETE. At least one of the sub-options must be selected if the notification option is selected. Based on user selections, notifications for print job problems or print job complete are included or excluded in instructions for the print job. For example, only notification of print job complete will occur for the print job of FIG. 3, since it is the only sub-option that is checked. A text box is included for entering a WIRELESS RECEIVER IDENTIFIER, such as a telephone number, network address, or other ID code. An OK button implements any user selections for the print job, and a default button implements any user selections for all print jobs.

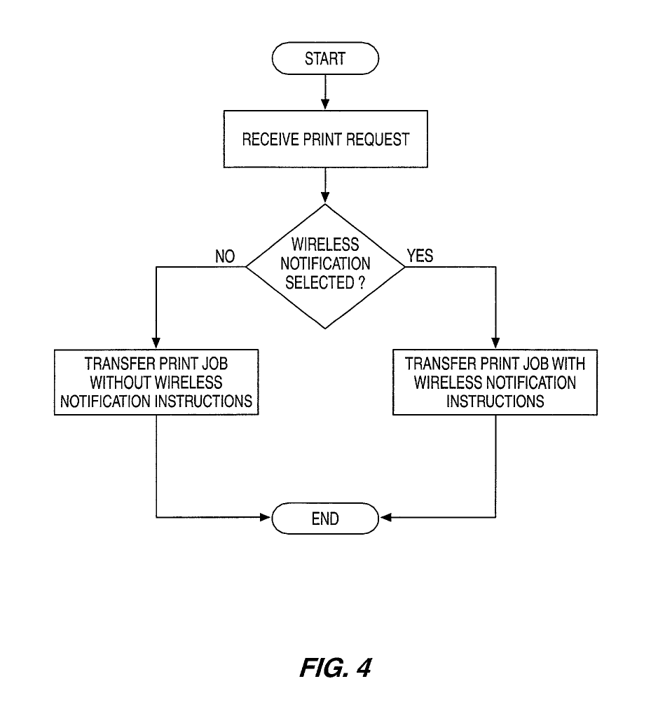

FIG. 4 is a flow diagram that illustrates initiating device 110 operation in an example of the invention. Initiating device 110 receives a print request. If wireless notification of print job status is a selected option for the print request, then initiating device 110 transfers the corresponding print job with notification instruction to printing device 120. If wireless notification of print job status is not a selected option for the print request, then initiating device 110 transfers the corresponding print job without any notification instruction to printing device 120.

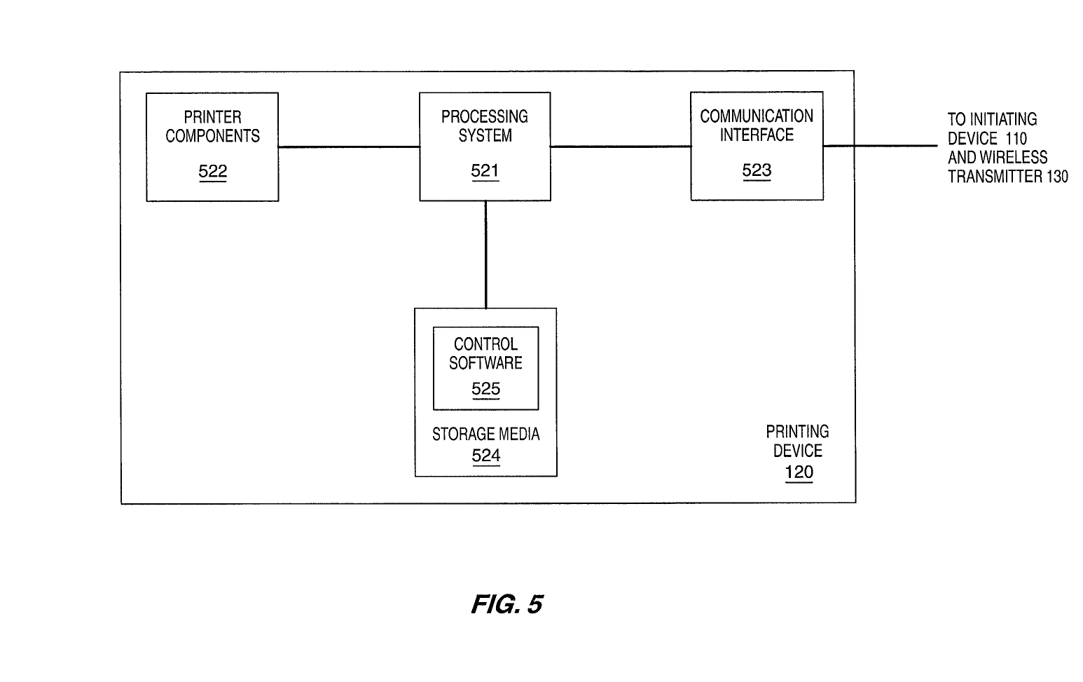

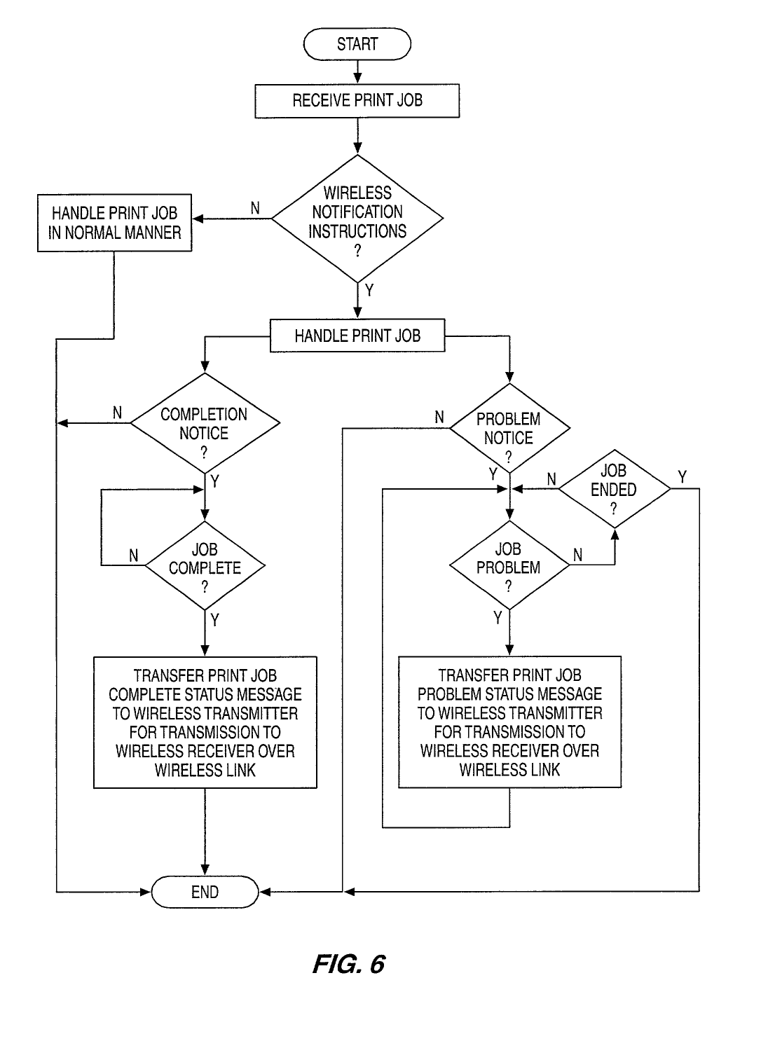

Printing Device—FIGS. 5-6

FIG. 5 is a block diagram that illustrates printing device 120 in an example of the invention. Printing device 120 is comprised of processing system 521, printer components 522, communication interface 523, and storage media 524. Storage media 524 stores control software 525. Communication interface 523 is operationally coupled to initiating device 110 and wireless transmitter 130. Communication interface 523 could be comprised of components, such as a network interface card, that facilitate communication with initiating device 110 and wireless transmitter 130. Printer components 522 perform the print jobs and could be conventional. Printing device 120 could be readily adapted from printing devices that are known in the art, such as the LASERJET 4050 supplied by Hewlett-Packard.

Processing system 521 includes computer circuitry to read and execute control software 525 from storage media 524. Storage media 524 could be disks, integrated circuits, tapes, servers, or some other type of memory device. Storage media 524 does not necessarily have to reside within printing device 120. Control software 525 could comprise any processor-readable instructions—including programs, firmware, or encoded circuitry—that are operational when executed by processing system 521 to direct processing system 521 to control the operation of printing device 120.

FIG. 6 is a flow diagram that illustrates printing device in an example of the invention. Printing device 120 receives a print job from initiating device 110. If the print job does not include instructions for wireless notification of print job status, then printing device 120 handles the print job in the conventional manner. If the print job does include instructions for wireless notification of print job status, then printing device 120 handles the print job and determines if the instructions include problem notification, completion notification, or both.

If the instructions include problem notification, and if there is a print job problem, then printing device 120 transfers a message to wireless transmitter 130 for transmission to wireless receiver 131 over wireless link 132. The message identifies wireless receiver 132 and indicates a print job problem. The problem notification process repeats until the print job ends—either it is completed or terminated.

If the instructions include completion notification, and when the print job is complete, then printing device 120 transfers a message to wireless transmitter 130 for transmission to wireless receiver 131 over wireless link 132. The message identifies wireless receiver 132 and indicates that the print job is complete.

FIGS. 1-6 and the above description depict a specific example of a printing system in accord with the present invention. Those skilled in the art will appreciate that some conventional aspects of the printing system have been simplified or omitted for clarity. Those skilled in the art will appreciate that the features described above could be combined in various ways to form multiple variations of the invention. Those skilled in the art will also appreciate variations of the printing system that fall within the scope of the invention. As a result, the invention is not limited to the specific example described above, but only by the following claims and their equivalents.

What is claimed is:

1. A printing system product comprising:
initiating software configured to direct an initiating device to receive a print request including a wireless notification request, and in response, to transfer a corresponding print job with wireless notification instructions to a printing device wherein the wireless notification instructions are configured to direct the printing device to transfer print job status over a wireless link to a wireless receiver that is different from the initiating device; and
a processor-readable storage media that stores the initiating software.

2. The printing system product of claim 1 wherein the initiating software is configured to direct the initiating device to collect an identification of the wireless receiver.

3. The printing system product of claim 1 wherein the initiating software is configured to direct the initiating device to collect a selection to either include or exclude print job completion in the print job status.

4. The printing system product of claim 1 wherein the initiating software is configured to direct the initiating device to collect a selection to either include or exclude print job problems in the print job status.

5. A printing system product comprising:
control software configured to direct a printing device to receive a print job with wireless notification instructions, and in response, to direct the printing device to perform the print job and transfer print job status over a wireless link to a wireless receiver that is different from an initiating device that transferred the print job; and
a processor-readable storage media that stores the control software.

6. The printing system product of claim 5 wherein, in response to print job completion, the control software is configured to direct the printing device to transfer the print job status indicating the print job completion over the wireless link to the wireless receiver.

7. The printing system product of claim 6 wherein the control software is configured to direct the printing device to transfer the print job status indicating the print job completion over the wireless link to the wireless receiver only if the wireless notification instructions include the print job completion in the print job status.

8. The printing system product of claim 5 wherein, in response to a print job problem, the control software is configured to direct the printing device to transfer the print job status indicating the print job problem over the wireless link to the wireless receiver.

9. The printing system product of claim 8 wherein the control software is configured to direct the printing device to transfer the print job status indicating the print job problem over the wireless link to the wireless receiver only if the wireless notification instructions include the print job problem in the print job status.

10. The printing system product of claim 5 wherein the control software is configured to direct the printing device to transfer the print job status over the wireless link to the wireless receiver by transferring a message to a wireless transmitter wherein the message indicates the print job status and identifies the wireless receiver.

11. A method of operating a printing system, the method comprising:
receiving a print job with wireless notification instructions;
performing the print job in response to receiving the print job; and
in response to receiving the print job, transferring print job status over a wireless link to a wireless receiver that is different from an initiating device that transferred the print job.

12. The method of claim 11 wherein transferring the print job status over the wireless link to the wireless receiver comprises, in response to print job completion, transferring the print job status indicating the print job completion over the wireless link to the wireless receiver.

13. The method of claim 12 wherein transferring the print job status indicating the print job completion over the wireless link to the wireless receiver comprises transferring the print job status indicating the print job completion over the wireless link to the wireless receiver only if the wireless notification instructions include the print job completion in the print job status.

14. The method of claim 11 wherein transferring the print job status over the wireless link to the wireless receiver comprises, in response to a print job problem, transferring the print job status indicating the print job problem over the wireless link to the wireless receiver.

15. The method of claim 14 wherein transferring the print job status indicating the print job problem over the wireless link to the wireless receiver comprises transferring the print job status indicating the print job problem over the wireless link to the wireless receiver only if the wireless notification instructions include the print job problem in the print job status.

16. The method of claim 11 wherein transferring the print job status over the wireless link to the wireless receiver comprises transferring a message from a printing device to a wireless transmitter wherein the message indicates the print job status and identifies the wireless receiver.

17. The method of claim 11 further comprising:
receiving a print request including a wireless notification request that includes an identification of the wireless receiver; and
in response to receiving the print request, transferring the print job with the wireless notification instructions from the initiating device to the printing device.

18. The method of claim 17 wherein receiving the print request including the wireless notification request comprises collecting an identification of the wireless receiver and a selection to either include or exclude print job problems in the print job status.

19. The method of claim 11 wherein transferring the print job status over the wireless link to the wireless receiver comprises transferring an instant message indicating the print job status over the wireless link to a wireless personal digital assistant.

20. The method of claim 11 wherein transferring the print job status over the wireless link to the wireless receiver comprises transferring an instant message indicating the print job status over the wireless link to a wireless mobile telephone.
